(19) United States
(12) Patent Application Publication
(10) Pub. No.: US 2015/0370773 A1
(43) Pub. Date: Dec. 24, 2015

(54) System for Generating and Completing Safety Evaluation Forms

(71) Applicant: 1Life Workplace Safety & Health Ltd., Winnipeg (CA)

(72) Inventors: Theolynn Leigh Heineman, Winnipeg (CA); Angel Lisandro Aguilar, Winnipeg (CA)

(21) Appl. No.: 14/310,263

(22) Filed: Jun. 20, 2014

(51) Int. Cl. G06F 17/24; G06F 3/0484; G06F 3/0483; G06F 17/30

(52) U.S. Cl. CPC G06F 17/243; G06F 17/248; G06F 17/30011; G06F 3/04842; G06F 3/0483

(57) ABSTRACT

A computer implemented system for exchanging safety information between a primary user and a secondary user, makes use of a server including a system memory storing programming instructions thereon, a form data database storing safety evaluation form data thereon in the form of safety questions relating to safety information, and a user interface arranged to receive input from the primary user and the secondary user. The programming instructions on the system memory include a form generating tool arranged to generate a prescribed safety evaluation form using the safety evaluation form data from the form data database according to input received from the primary user, a form completion tool arranged to append response data to the prescribed safety evaluation form according to input received from the secondary user to generate a completed form, and a form reviewing tool arranged to provide access to the completed form by the primary user.

### FIELD OF THE INVENTION

The present invention relates to a system implemented on a computer server to enable a primary user to generate a digital safety evaluation form comprised of safety questions and enable a secondary user to append response data to the generated form such that once completion of the form is approved by the primary user, both users are provided access to a copy of the approved safety evaluation form on the computer server.

### BACKGROUND

In the trades industry, there are countless potential liabilities faced by companies when hiring sub-contractors or vendors to do work. Assessing, qualifying and managing sub-contractors can be a huge administrative burden, but is necessary on the part of contractors to protect themselves and their companies from legal and financial impact caused by a sub trade. More particularly, contractors are required to ensure that they are using sub-contractors who are compliant with safety rules and regulations and which meet job specific requirements, including insurance matters, OH&S policies, licenses, memberships, and general records relating to work being performed. Some requirements vary dependent upon jurisdiction and job type, such that it can be difficult and time consuming for contractors to manage all aspects related to job safety requirements.

Various attempts have been made in the prior art to assist contractors in evaluating different sub-contractors to assist in the sub-contractor selection process, but no prior art system is particularly suited to assist in the generation of safety related documentation to assist contractors in managing safety related risks.

### SUMMARY OF THE INVENTION

According to one aspect of the invention there is provided a computer implemented system for exchanging safety information between a primary user and a secondary user, the system comprising:

a server including a system memory storing programming instructions thereon, a form data database storing safety evaluation form data thereon in the form of safety questions relating to safety information, and a user interface arranged to receive input from the primary user and the secondary user;

the programming instructions on the system memory further comprising:
a form generating tool arranged to generate a prescribed safety evaluation form using the safety evaluation form data from the form data database according to input received from the primary user;
a form completion tool arranged to append response data to the prescribed safety evaluation form according to input received from the secondary user to generate a completed form; and
a form reviewing tool arranged to provide access to the completed form by the primary user.

According to a second aspect of the present invention there is provided a method of exchanging safety information between a primary user and a secondary user using the system according to any one of claims 1 through 20, the method comprising:

receiving safety data selection information from the primary user through the user interface;

using the form generating tool, creating a safety evaluation form using safety evaluation form data from the form data database selected according to the safety data selection information from the primary user;

receiving response data from the secondary user through the user interface;

using the form completion tool, creating a completed form comprising the safety evaluation form and the response data appended thereto; and

using the form reviewing tool, enabling the primary user to view the completed form.

For a contractor, the system according to the present invention can help ensure that they are dealing with sub-contractors who are compliant and/or meet the relevant job specific requirements. The system is provided with wizards which will store all relevant documentation including insurances, OH&S policies, licenses, etc. to help keep records up to date. The system can allow contractors to: i) Create customized electronic contractor safety evaluations based on their specific jurisdiction, jobs and risks; ii) Create customized electronic contractor safety evaluations based on their specific jurisdiction, jobs and risks; iii) Share and track critical information with their sub-contractors; iv) Send to their sub-contractors electronically and track their progress; v) Create permanent records; and vi) Ensure business continuity and that due diligence has been followed.

For a subcontractor, the system according to the present invention can help them create professional, customized and job specific contractor evaluations of their own organization to gain a competitive advantage. More particularly, the system allows them to submit documentation with their job bids to ensure priority consideration as bids are evaluated by demonstrating that they are reducing clients risk. More particularly the system can allow subcontractors to: i) Pre-qualify for jobs and increase their business opportunities; ii) Reduce their own Insurance and WCB Costs; iii) Demonstrate regulatory knowledge and compliance; iv) Document the qualifications of their temporary, seasonal and full time work force; v) Upload their documents once and efficiently provide required documents to all of their contractors (Certificate of Insurance, OH&S policies, WCB documents, licenses, memberships, company policies . . . etc).; vi) Create customized electronic contractor safety evaluations based on their specific jurisdiction, jobs and risks; vii) Know what qualifying questions to ask their contractors when stating a hazard or risk; viii) Share and track critical information with their contractors; ix) Send to their contractors electronically and track their progress; x) Create permanent records; xi) Ensure business continuity and that due diligence is followed.

Preferably the system further comprises: i) the user interface being arranged to receive input from the primary user including custom safety questions; and ii) the form generating tool being arranged to generate the prescribed safety evaluation form using both the safety evaluation form data from the form data database and the custom safety questions according to the input received from the primary user.

Preferably the system further comprises: i) the form data database including a plurality of designated categories including a plurality of safety questions associated with each category; ii) the user interface being arranged to receive input from the primary user including at least one category selection; and iii) the form generating tool being arranged to generate the prescribed safety evaluation form using the safety questions associated said at least one category selection.

Preferably the system further comprises: i) the form data database including a plurality of general safety questions independent of the designated categories; and ii) the form generating tool being arranged to generate the prescribed safety evaluation form using both the safety questions associated said at least one category selection and some of the general safety questions according to the input received from the primary user.

Preferably the system further comprises: i) the user interface being arranged to receive input from the primary user including a customization selection; and ii) the form generating tool being arranged to generate the prescribed safety evaluation form using only a portion of the safety questions associated said at least one category selection responsive to said customization selection by the primary user.

Preferably the system further comprises: i) the user interface being arranged to receive input from the primary user including an attachment document; and ii) the form generating tool being arranged to generate the prescribed safety evaluation form such that the attachment document is appended therewith.

Preferably the system further comprises: i) the system memory including a primary user database storing the attachment document thereon; and ii) the form generating tool being arranged to generate a plurality of different safety evaluation forms using the attachment document stored on the primary user database and the safety evaluation form data from the form data database according to the input received from the primary user.

Preferably the system further comprises the form generating tool being arranged to append a plurality of attachment documents to different one of the safety questions respectively.

Preferably the system further comprises: i) the user interface being arranged to receive input from the secondary user including an attachment document; and ii) the form completion tool being arranged to generate the completed form such that the attachment document appended therewith.

Preferably the system further comprises: i) the system memory including a user database storing any generated and completed forms thereon; and ii) the user interface including a display tool arranged to present all forms for selection by the user and display any selected form to the user.

Preferably the system further comprises: i) the system memory including a user database storing a plurality of user form templates thereon which are accessible to a prescribed user; ii) the user interface being arranged to receive input from the primary user including a template selection; and iii) the form generating tool being arranged to generate a prescribed safety evaluation form using the form template corresponding to the template selection together with the safety evaluation form data from the form data database.

Preferably the system further comprises: i) the user interface being arranged to receive a template customization selection from the primary user; and ii) the form generating tool being arranged to modify one of the user specific from templates stored on the user database in accordance with the template customization selection from the primary user.

Preferably the system further comprises: i) the form data database including a plurality of master form templates thereon accessible to a plurality of different users; ii) the user interface being arranged to receive input from the primary user including a template selection; and iii) the form generating tool being arranged to generate a prescribed safety evaluation form using the master template corresponding to the template selection together with the safety evaluation form data from the form data database.

Preferably the system further comprises: i) the system memory including a user database accessible only to a prescribed user; ii) the user interface being arranged to receive a template customization selection from the primary user; and iii) the form generating tool being arranged to modify one of the master form templates in accordance with the template customization selection from the primary user and store the modified template on the user database.

Preferably the system further comprises: i) the user interface being arranged to receive a user authorization from each of the primary user and the secondary user; ii) the programming instructions on the system memory further comprising a connection management tool; iii) the connection management tool being arranged to establish an authorized connection between the primary user and the secondary user in response to the user authorization from the primary user and the user authorization from the secondary user; and iv) the connection management tool being arranged to enable display of the generated safety evaluation form to the secondary user only subsequent to the authorized connection between the primary user and the secondary user having been established.

Preferably the system further comprises: i) the system memory including a connection database; ii) the connection management tool being arranged to store the authorized connection on the connection database; and iii) the connection management tool being arranged to enable display to the secondary user of a plurality of different safety evaluation forms generated by the primary user subsequent to the single authorized connection between the primary user and the secondary user having been established.

Preferably the system further comprises each authorized connection being stored on the connection database as a first connection authorizing communication of forms by the primary user for display to the secondary user and a second connection authorizing communication of forms by the secondary user for display to the primary user.

Preferably the system further comprises: i) the programming instructions on the system memory further comprising a communication management tool; and ii) the communication management tool being arranged to send a notification through a communications network to the secondary user upon generation of the prescribed safety evaluation form by primary user using the form generating tool.

Preferably the system further comprises: i) the programming instructions on the system memory further comprising a communication management tool; and ii) the communication management tool being arranged to send a notification through a communications network to the primary user upon generation of the completed form by the secondary user using the form completion tool.

Preferably the system further comprises the form reviewing tool being arranged to associate a status of the response data in relation to each question on the completed form using status input received from the primary user using the user interface.

Preferably the system further comprises: i) the form reviewing tool being arranged to associate an accepted status or a rejected status to the response data within the completed form using status input received from the primary user using the user interface; and ii) the system being arranged to enable further response data from the secondary user to be appended to the prescribed safety evaluation form using the form completion tool in response to a rejected status being associated with the completed form using the form reviewing tool.

One embodiment of the invention will now be described in conjunction with the accompanying drawings in which:

### BRIEF DESCRIPTION OF THE DRAWINGS

FIG. 1 is a simple system deployment schematic of the computer implemented system according to the present invention;

FIG. 2 is a schematic overview of various functional components of the system;

FIG. 3 is a schematic overview of the user interface display component of the system;

FIG. 4 is a schematic representation of the digital safety evaluation form;

FIG. 5 is a flow chart representing the process of creating a safety evaluation form;

FIG. 6 is a process activity diagram of the safety evaluation form approval process;

FIG. 7 is a state diagram of the safety evaluation form;

FIG. 8 is schematic representation of the safety evaluation form life cycle;

FIG. 9 is a display image of the overview step when creating a new safety evaluation form using the form generating wizard tool;

FIG. 10 is a display image of the contractor information step in the creation process according to FIG. 9;

FIG. 11 is a display image of the overview questions step in the creation process according to FIG. 9;

FIG. 12 is a display image of the jobs step in the creation process according to FIG. 9;

FIG. 13 is a display image of the hazards step in the creation process according to FIG. 9;

FIG. 14 is a display image of a hazard addition step in the creation process according to FIG. 9;

FIG. 15 is a display image of a sample hazard question in the creation process according to FIG. 9;

FIG. 16 is a display image of the question checking step in the creation process according to FIG. 9;

FIG. 17 is a display image of the additional questions step in the creation process according to FIG. 9;

FIG. 18 is a display image of an exemplary additional question step in the creation process according to FIG. 9;

FIG. 19 is a display image of an additional information step in the creation process according to FIG. 9; and

FIGS. 20A and 20B are a schematic representation of the connections activity between two users of the system.

In the drawings like characters of reference indicate corresponding parts in the different figures.

### DETAILED DESCRIPTION

Referring to the accompanying figures there is illustrated a computer implemented system generally indicated by reference numeral 10. The system 10 is particularly suited for generating safety evaluation forms for the exchange of safety related information between different users of the system. More particularly, the system is used by a primary user, for example a contractor, to generate a form comprising a plurality of safety related questions to be sent to a secondary user, for example a subcontractor, to ensure that sufficient information is collected from the secondary user for the primary user to conduct all due diligence required in following safe workplace practices throughout a project.

The system 10 generally includes a system server 12 in the form of one or more computers at a single location or distribution through many locations in a network so as to be suitably arranged for executing the various functions of the invention as described in the following. The server has a memory which stores various forms of databases thereon. The information contained in the databases is used by programming instructions also stored in the memory in the form of various tools. Each tool is understood to comprise one or more algorithms or programming modules to effect one or more various functions of the tool as described herein.

The server is connected through suitable communications network 14, for example the internet, to a plurality of user. Each user typically uses their own computer device 16 in communication with the server through the communications network 14. The computer device of the user includes its own memory with programming instructions stored thereon including a browser, a graphical display for displaying content access through the browser, and a suitable connection for communication with the network. The server includes a suitable user interface display tool 18 for generating the content to be viewed on the user's respective browser.

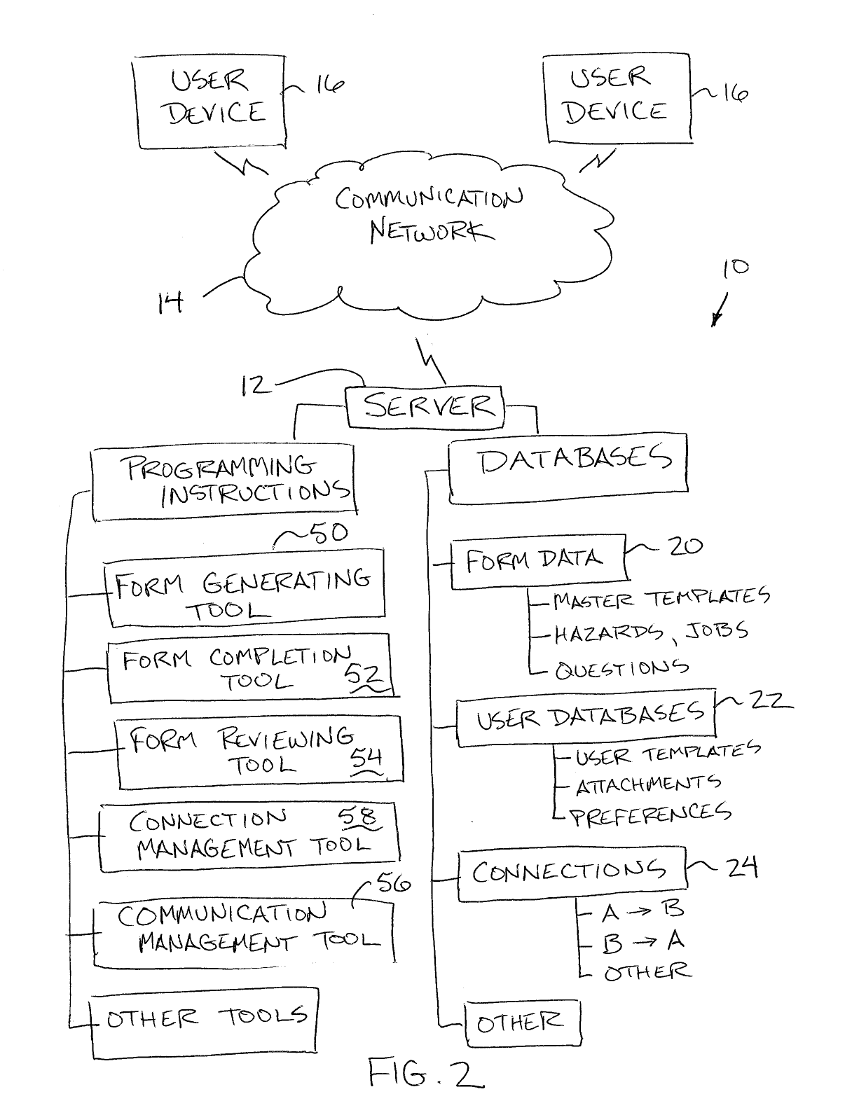

As shown in FIG. 2, various forms of databases are provided for storing the various types of data used by the system. Among the databases there is provided a form data database 20 which stores a plurality of safety questions thereon used by the system to generate the safety evaluation forms. The safety questions which form the safety evaluation form data can be stored as individual questions, or various groups of safety related questions can be organized within a respective category, for example a specific job type or a specific type of hazard to be encountered on a specific job site. The form data may also include various forms of master templates of safety evaluation forms which have already been generated but which can be customized.

The databases also include a plurality of user databases 22 to store various user specific data thereon. Examples of user specific data include customized hazards or jobs including respective groups of safety questions already associated therewith as selected by the user, or other individual safety questions selected by the user. Individual users of the system may also generate their own safety evaluation templates, either by modifying a master template or by generating their own form through a form creation process as described in further detail below. Other forms of user specific date include various forms of attachments in the forms of permits and the like which may be specific to a user or job site.

The system also includes a connections database 24 which stores various connection authorizations between different users thereon. In this manner, once one user has authorized a connection for exchanging information with a second user, the authorization is stored to also permit further communications between the respective users. The connection between the primary user and the secondary user is typically stored as two separate connections. A first connection authorizes the primary user to communicate with the secondary user, and the second connection authorizes the second user to communicate with the first user. Each user owns only the connection which authorizes it to send data to the other party such that each user is only authorized to edit preferences and permissions relating to their own authorization to send data to the other party.

The system also includes various tools to execute various functions based upon input received from the respective users. The user interface communicates over the communications network with the respective browsers of the users to receive input through their respective computer devices in various forms. User input can take the form of question selections by the primary user when creating a safety evaluation form such as the selection of specific individual questions to be added to the form, the selection of various categories of jobs or hazards resulting in associated groups of questions to be added to the form as well as various customization selections. The customization selections can relate to removal or amendment of one or more questions added individually or as a group to a safety evaluation form in progress.

Other user input can include various attachment documents uploaded by the user to the server. Various attachment documents can include various forms of construction permits, licences for performing various services, or various work plans and the like. The attachments may be appended to specific questions of a form or generally to a form in progress, or may be simply stored on a respective user database associated with that user for use in attachment to subsequently generated safety evaluation forms.

Other input received by the user may take the form of user form template selections or master template selections, as well as customization selections by the user used to customize an already selected template.

Other input received by respective users relates to user authorizations which permit connections to be established between different users which in turn authorizes subsequent exchange of information between the users once a connection has been established.

Other input by the users relates to various forms of comments or messages which can be directed by the server to specific users either directly or by being appended to a safety evaluation form in progress, or more specifically appended to specific questions within a pending safety evaluation form.

Generally, there are three different account types for the system. One account type is simply an overall administrator account which accesses the overall system for controlling default safety questions associated with specific hazards and master templates for example. Regular users of the system typically fall into one of two categories. These include a contractor or administrator account in the form of a paid account which permits a user to both generate forms and send forms to other users when acting as a primary user or contractor, as well as receive forms generated by others for completion as a secondary user or subcontractor. Other user accounts may take the form of a guest account which is a free account permitting the user to only act as a secondary user which receives forms created by others for completion. Connections can be made between any contractor account and any other contractor or guest account.

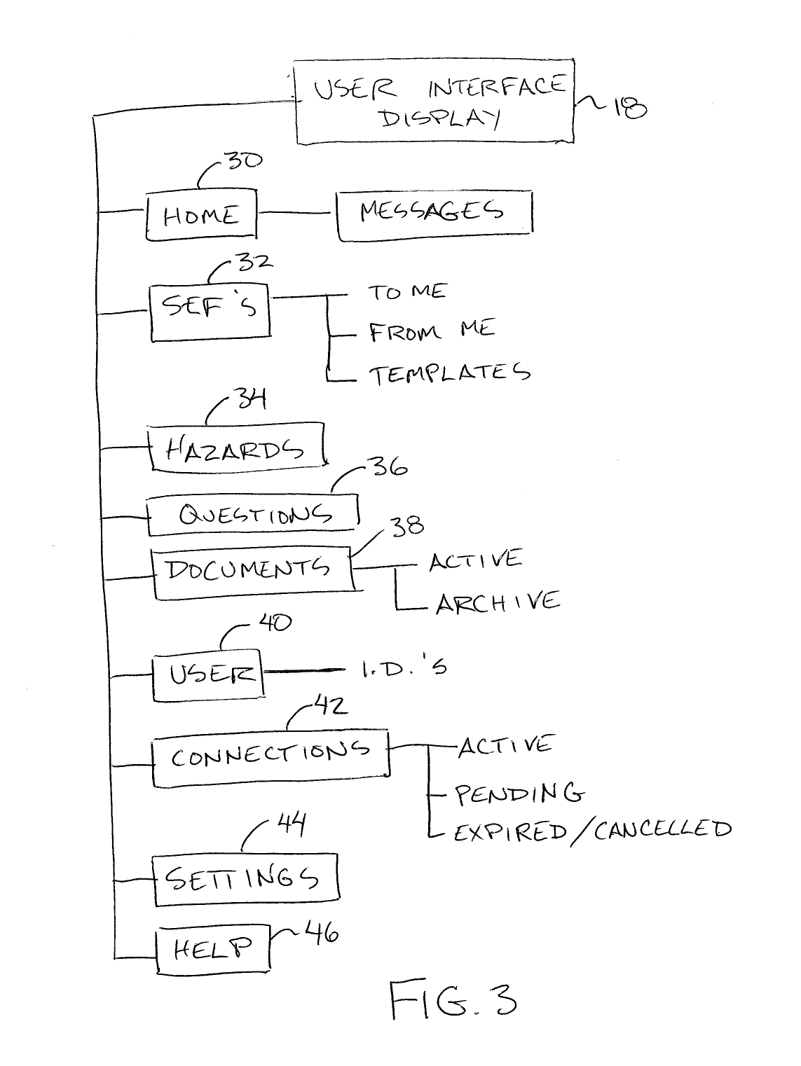

As shown in FIG. 3, the user interface generally includes a display tool 18 which is arranged to present various data for display on the respective browser of an individual user. The information is organized according to a plurality of separate categories as described in the following.

A home tab 30 summarizes all active messages for the user including direct communications between users of the system as well as system notifications generated by various tools of the system for notifying a user of any event or changes of status of various documents in progress. The various messages associated with each user are stored separately according to user in respective mail boxes as part of a communication management tool described in further detail below.

The main interface further includes a safety evaluation form tab 32 which presents safety evaluation forms in various stages for ready access to the user. Specifically the forms are separated into a first category of forms which are generated by the respective user for being sent to other users and a second category of forms generated by other users and sent to the respective user associated with the main display. The various forms stored according to the user in the user database also include customized user form templates which can be accessed for creating new forms. Various functions for generating new forms according to the safety evaluation form generating tool are accessed through the safety evaluation form tab 32.

A hazards tab 34 is included which in some implements of the invention can provide the user with access to their own customized hazards having their own selection of respective safety questions associated therewith. Accordingly, when creating a new safety evaluation form, in addition to data from the form data database 20, the user may also be able add questions by selecting one of their own customized hazards saved under the hazards tab of their own user database.

The main user interface associated with each user further includes a customized questions tab 36 where the user can add and save specific customized questions that can be used in creating safety evaluation forms.

A documents tab 38 provides access to the user specific library of attachment documents uploaded to the system by the user. Documents can be stored in the user library along with relevant associated information appended therewith such as a description of the document, relevant expiry date information or other relevant information. Other examples of documents which may be attached include permits, site plans, emergency contact information, safety rules or specific policies, material safety data sheets or any other document which may be desired to be attached as relevant safety information. In addition to an active library, an archive can also be accessed through the documents tab 38 which stores documents that have been moved from the library when they are not as readily required any longer.

The user interface further includes the user tab 40 which summarizes which specific individuals can use a specific user account by associating a respective log-in ID and respective password with each of the different individual users. Different individuals within a respective user account may be provided with different permissions such as the permission to create new forms or the permission to only respond to already created forms.

A connections tab 42 of the user interface permits the user account to monitor all authorized connections associated with that user. The authorized connections include active connections, pending connections where one user has invited another user without confirmation, or inactive connections which result from one or both users cancelling or declining an established or pending connection.

User interface further includes a settings tab 44 which presents various preferences for access by the user for editing as desired. Preferences include the types of notifications to be sent to the users, company information such as contact information and personal information such as a particular individual user's information and password and the like.

A help tab 46 is also provided on the user interface to access various resources, to communicate with the overall administrator, to view various tutorials in the form of video presentations on specific topics relating to the system, and any other potentially helpful information to individual users.

Turning now back to FIG. 2, the various tools of the programming instructions will now be described in further detail.

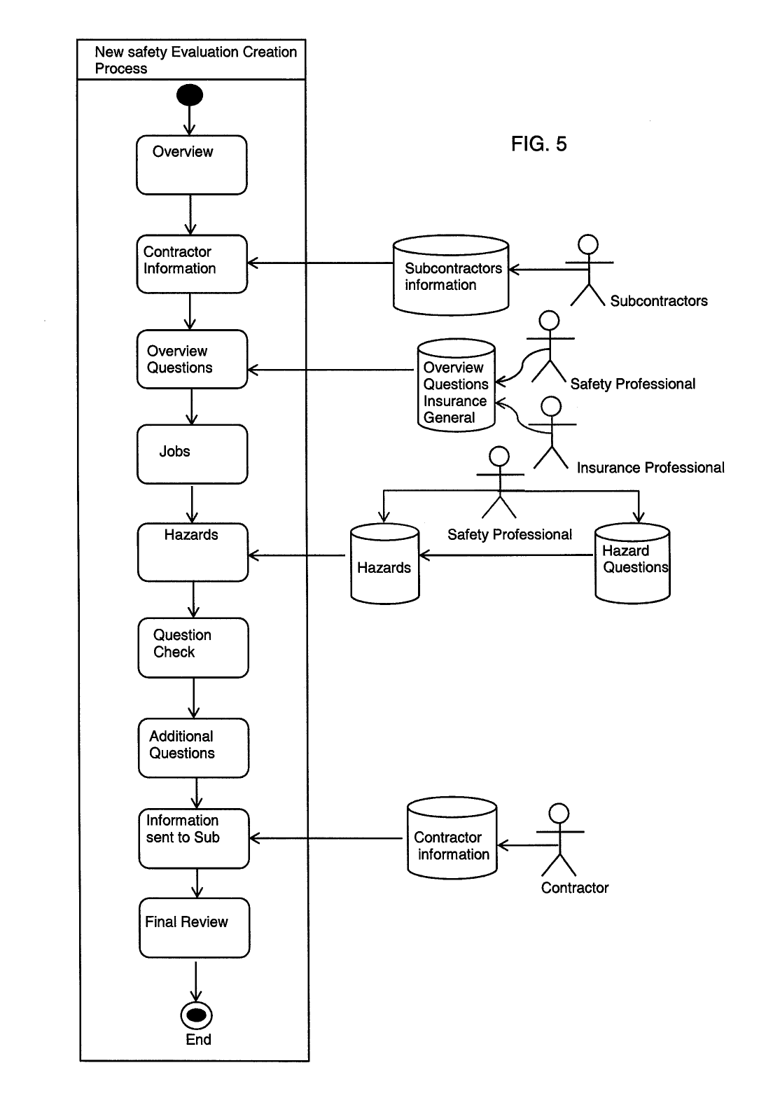

One of the tools is a form generating tool 50 which is arranged to generate a prescribed safety evaluation form using various safety evaluation form data from the databases in accordance with input received from the primary user. The general creation process is summarized in FIG. 5. The user initially provides specific contractor and sub-contractor information which may be already stored on the database or received from user input. General contractor information includes naming the form, a project name, and names of the users involved. Specific sub-contractor information can be obtained by the system by accessing the user databases.

Upon entering contractor information, various overview questions are selected for inclusion in the safety evaluation forms. These questions may not necessarily be job specific but may be mandatory or suggested questions relating to general information about the safety of the individuals involved or in relation to insurance for example. Questions can include a number of employees or various insurance related questions for example.

Once the overview selections have been selected, the user typically adds a job description relating to specific tasks required, for example electrical, plumbing, excavation and the like. The user then selects various hazards which may be relevant to the various jobs or the overall project as a whole. The hazards may be associated with specific tasks referenced in the job description or may relate more generally to the project. The user may select individual questions from the form database or may simply make a hazard selection such that a plurality of safety questions associated with that category of hazard within the form data database are automatically added to the safety evaluation form as a group. Further input may be received from the user to customize any of these proposed questions include adding or removing questions as desired. Each question can be further customized to require an additional attachment document as a requirement for fully answering the specific question. For example, a specific question may require an attachment of a valid license with expiry information. The user is then permitted to preview the overall list of assembled safety questions forming the safety evaluation form and is further provided with an opportunity to add any additional questions including the option to request file attachments and the like. Once the user has completed the steps of the form generating tool, the pending safety evaluation form is sent to the secondary user to receive their answers appended to each of the questions. Information from the secondary user is appended to the safety evaluation form in a completion process of the form using a form completion tool 52 which is described in further detail below.

Prior to sending the generated safety evaluation form to the sub-contractor, a further opportunity is provided to append additional information in the form of information relating specifically to the contractor or job conditions such as a safety manual for specialized equipment on site for example. The attachment documents are uploaded through the user library portion of the respective user database. A final review is conducted after all attachments have been associated with the generated form prior to sending to the subcontractor. Once approved for sending, the system automatically stores a copy of the pending form among the list of other forms associated with that user within the respective user's database. The system also automatically generates a suitable notification which is sent to the secondary user using a communication management tool 54 described in further detail below.

A copy of the form is listed with other forms under the safety evaluation forms tab 32 of the user database where all other forms associated with that user are also listed. The forms are categorized and listed by status including i) a created status indicating a form has been fully or partially created but not sent, ii) an in-progress status indicating a generated form has been sent but not completed, iii) an active status indicating a completed form has been accepted, iv) as well as additional statuses relating to cancelled, declined, rejected or expired forms.

As described herein, the form generating tool is capable of generating safety evaluation forms according to various input and criteria established by the user and using data supplied by the system. For instance, each safety evaluation form can be created using a combination of form data from the form data database together with custom safety questions inputted by the primary user either as individual questions or as categories selections resulting is associated questions with a specific category being added. The form generating tool further allows the user to customize the created form by adding new questions, amending existing questions, removing non-applicable questions associated with a particular category, attaching documents generally to the form or to specific ones of the questions of the form and the like. All questions of the form may be generated simply by designating specific questions or hazards, or alternatively a specific user template or master template can be selected as the starting point from which further customization selections permit questions to be added, amended or removed and the like.

The form completion tool 52 is typically used by the secondary user to append response data to the prescribed safety evaluation form according to input received from the secondary user to generate a fully or partially completed form for subsequent review by the primary user. The form completion tool permits i) an answer, ii) additional comments, and iii) one or more attachments to be appended to each individual question of the overall form according to the input received from the secondary user. Upon initial completion of the form, a status of each question is established as being either complete or incomplete. In some instances, the secondary user may not be able to provide an answer due to some further clarification required. In this instance, the completed form returned to the user may include a status of incomplete associated with one or more questions together with comments or questions appended thereto for attention by the primary user before the secondary user can continue to complete the form.

The secondary user is provided with a user interface substantially identical to the user interface of the primary user as described in relation to FIG. 3, however if the secondary user is using only a guest account, their safety evaluation form tab 32 will only include a category of forms sent to the user with no listing of forms created by the user and with no options provided to create new forms as the guest user in this instance is only permitted to view forms created by others for completion by that user. The secondary user is still permitted to upload various documents to be stored under their respective documents tab which represents attachment documents stored on the respective user's library in the databases of the server.

The secondary user typically logs into the system and under their respective user interface selects one of the forms to be completed under the respective safety evaluation form tab. The user interface display then converts to an answer mode in a split screen format. On the left side information generated in the form is presented including individual questions and any file attachments which have been attached by the primary user. On the right side of the screen, the secondary user is provided with an answer box where a description or answer can be included. A separate file tab is provided for attaching documents by the secondary user. An additional revisions tab may be provided for tracking the history of answers and revisions to a specific question. The status of each question is typically provided in the form of “answered and complete”, “answered and incomplete”, or “in need of clarifications”. For each question, the secondary user uses the form completion tool to add an answer which may include attaching files or other relevant information including an expiry date if applicable. The status of each answer is also determined prior to overviewing the entire form. Once the secondary user is satisfied with their response data appended to the generated form, the secondary user then approves the system to return the completed form to the primary user for review. The system automatically converts the status of the form stored on the system server back to a form which can be only edited by the primary user or contractor.

The primary user accesses the completed safety evaluation form for review prior to final acceptance using a form reviewing tool 54. The form reviewing tool permits the primary user to review the answers of all of the questions using a similar split screen arrangement with the question on one side with appended files and the like, and with appended response data by the secondary user on the right side including answer information, comments, and files appended by the secondary user. The form reviewing tool permits the contractor to label a status with each individual question as either accepted or rejected or requiring further clarification in response to a comment by the contractor for example.

The review process by the contractor is initiated when the system sends a message to the home tab 30 of the user interface that a contractor action is required as one of the forms has been completed and ready for review. The contractor logs into the system and selects the appropriate form pending review from the respective safety evaluation form tab 32 of their interface. An overview of the completed form can be completed on screen or printed to PDF for review. In converting the safety evaluation form into a preview on screen or a printable PDF format, all questions of the form along with any relevant attachments are collectively assembled into continuous document for display to the primary user. The attached files are typically appended at the end of the questions forming the basis of the safety evaluation form. In addition to updating the status of each individual question, the contractor is also permitted to add additional questions prior to sending back to the secondary user. The status of each question may be any one of the following: Accepted, Rejected, Complete, Incomplete, Unanswered, or Need Clarification. A revision history associated with each question is also stored and appended to the safety evaluation form during the review process.

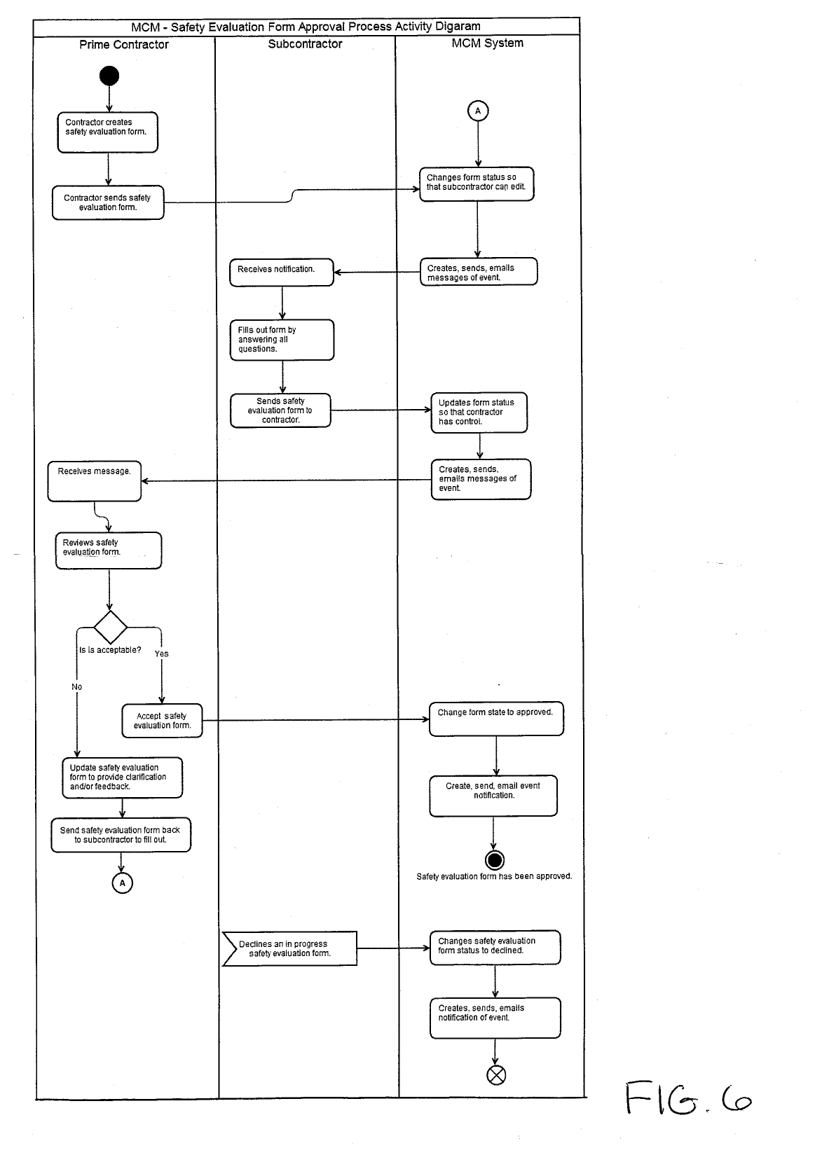

An overview of the safety evaluation form approval process is represented schematically in FIG. 6. As illustrated, the contractor initially creates the safety evaluation form as described above and then approves the generated form to be sent to the second user. The system automatically edits the status of the form saved on the system such that the primary user no longer has access to further update the document, but instead the secondary user receives notification through the communication tool of the system that the form is now accessible and ready for completion by the secondary user. The system may further send notification through an external communication network such as an email or other electronic message sent to a mobile device for example.

Upon receiving the notification, the secondary user submits input through the user interface in the form of response data which is appended to individual questions of the safety evaluation form to answer all questions. Upon satisfactorily completing the form, the secondary user approves the form to be returned to the primary user. In response to this approval, the system updates the status of the form as viewed by both the primary and secondary users and changes the editing control from the secondary user back to the primary user. In doing so, the system also uses the communication management tool to send notifications internally and through external communication networks to the primary user to indicate that the completed form is ready for review.

Upon receipt of the notification, the primary user then uses the form reviewing tool to view the response data appended to each individual question by the secondary user. An approval status is determined by the primary user and is appended to each question upon review. If any question is not accepted, the overall form is rejected and the primary user typically attaches comments or questions requesting how the form must be amended to be satisfactorily completed. The primary user or contractor then authorizes the form to be returned to the secondary user for further completion. In response to this approval, the system again changes the status of the form as viewed by both the primary and secondary users and sends the appropriate notification to the secondary user that the form is again ready for their further completion. The authorization to edit the form is again reverted from the primary user to the secondary user in this instance. Alternatively, if all answers are considered acceptable, the overall safety evaluation form in its completed form is accepted by the primary user and a corresponding input is received by the system from the primary user. In response to this input, the status of the form is updated by the system to an approved status and corresponding notifications are sent to both users regarding the approved status. Access to a copy of the completed and approved form is provided through the user interface of both the primary and secondary users for subsequent viewing as desired. The system also generates a printable copy of the safety evaluation form in which all appended data is attached together with the questions and the appended response data as a continuous document.

At any time in the process, either party may cancel or decline an “in progress” form which results in the system automatically updating the status to both users and notifying the users appropriately.

Among the various tools, the system further includes a connection management tool 58 which assists in establishing an authorized connection between different users of the system to permit the exchange of safety evaluation form data therebetween. The system only permits a secondary user to access a form generated by the primary user once the connection between the two parties has been established. In the instance of both users already being registered with the system, the primary user is only required to identify which secondary user they wish to communicate with and the system will notify the secondary user that the primary user wishes to establish a connection with them. Upon receipt of the appropriate authorizing input from the secondary user, the system will establish an authorized connection between the two users.

Once an authorized connection has been made, the established connection is saved in the connections database for future reference in communicating other safety evaluation forms in the future between the parties. At any time, either one of the users may terminate the authorization to remain connected. This results in the connection changing status from an active current connection to an inactive connection. The status of the various connections belonging to any one user are listed under the respective connections tab 42 of that user's interface. When a first user contacts a second user requesting authorization to make a connection therewith the status of the connection is listed as “pending” under the connections tab 42 until the secondary user confirms approval of the connection.

Turning now to FIG. 4, the general structure of the safety evaluation form will now be described. Overall, the safety evaluation form is effectively a digital representation of a form containing safety questions relevant to workplace safety. Within the overall file representing a single safety evaluation form, various types of data are included therein. The various types include information about the contractor, information identifying the subcontractor, various questions to be posed by the contractor for the subcontractor to answer and additional verification information. The questions can be organized into general overview questions, for example insurance questions or general contractor information questions, individually added safety questions, and safety questions which are included within a category such as specific hazard questions or relating to a specific job category. Each of the various data types includes a field to be completed by the primary user and a secondary field to be completed by the secondary user in response to the information posted by the primary user. Various attachment documents can also be included in the overall file structure by reference or in appended form in association with the form in general or with specific questions within the overall structure of the form.

Throughout the creation process of the safety evaluation form the state of the form varies throughout its creation process as represented schematically in FIG. 7. The editing control for updating information within the digital file representing the overall safety evaluation form varies between the primary user and the secondary user throughout the creation process. The form is initially created using the form generating tool 50 under editing control by the primary user. The initial form can be generated before or after an authorized connection has been made to the secondary user, but the form can only be approved for being sent by the system to the secondary user upon an established connection between the two users being authorized. The prime user can provide approval input which authorizes the system to automatically send the generated form for completion to the secondary user upon approving an established connection between the two users if the connection has not yet been made.

Once sent to the secondary user, the secondary user uses the form completion tool 52 such that editing control is converted over from the primary user to the secondary user under control of the system. Upon completion of the form in a manner satisfactory to the secondary user, the secondary user authorizes the system to revert editing control back to the primary user. The primary user then uses the form reviewing tool 54 to review and make changes or approve the form as desired. At any time, the primary or secondary users can either cancel or decline the pending form if desired. At the review stage by the primary user using the form reviewing tool, if any aspect of the form is rejected, the editing control reverts to the sub-contractor or secondary user using the form completion tool 52 again. Alternatively, if the form is accepted by the primary user, the form is saved in accepted form by the system and an approved copy is provided for access to both users through their respective user interfaces. An expiration date is also associated with the form such that the system is arranged to automatically update the status of the form from an approved status to an expired status upon reaching the expiry date.

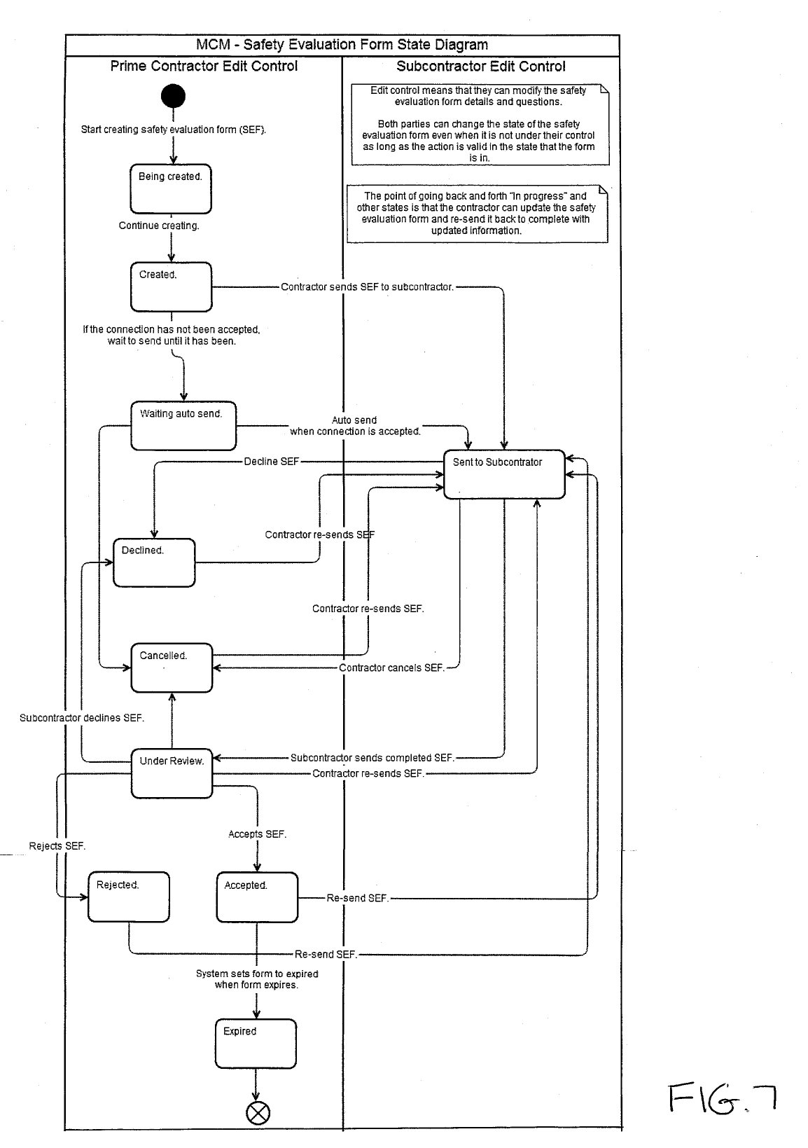

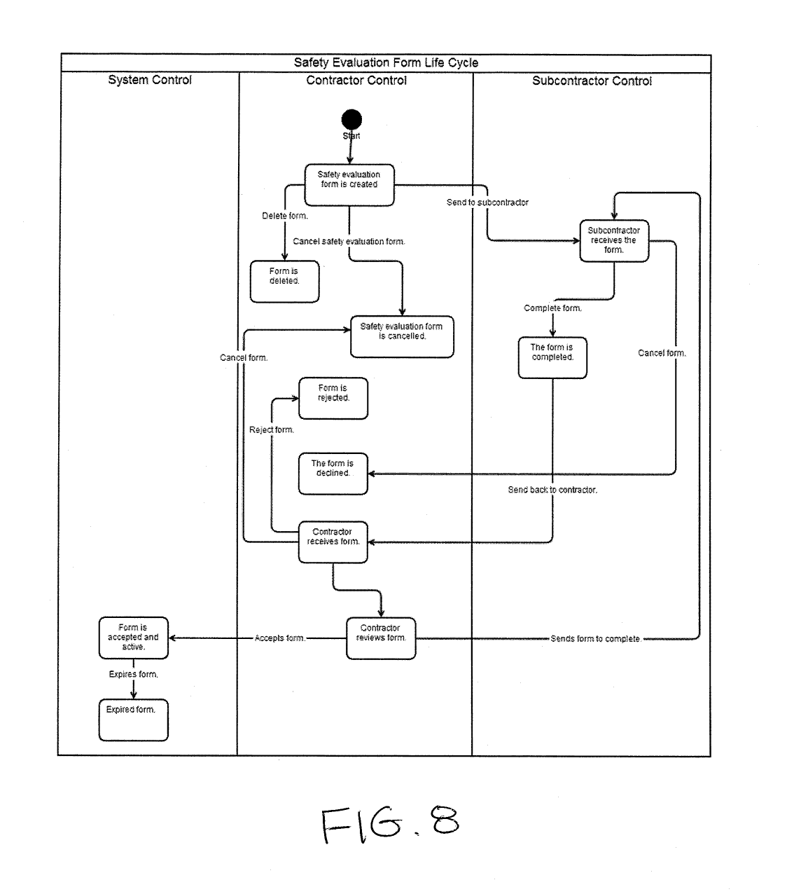

The general life cycle of the creation and approval process of a safety evaluation form is also schematically represented in FIG. 8.

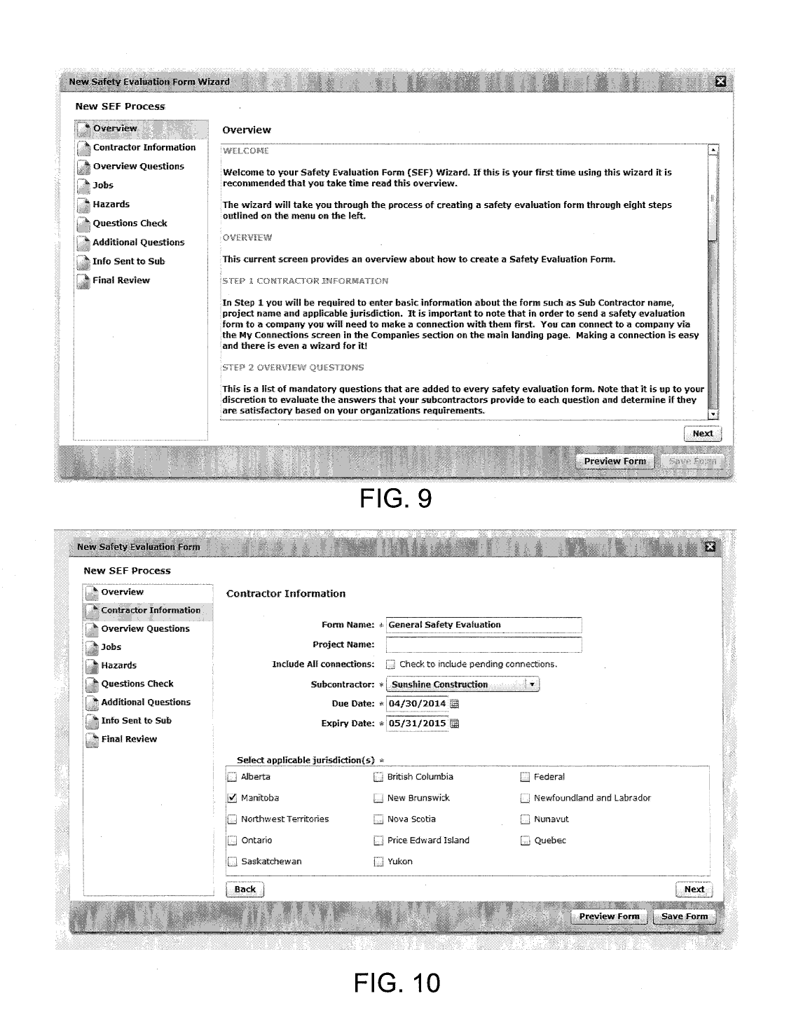

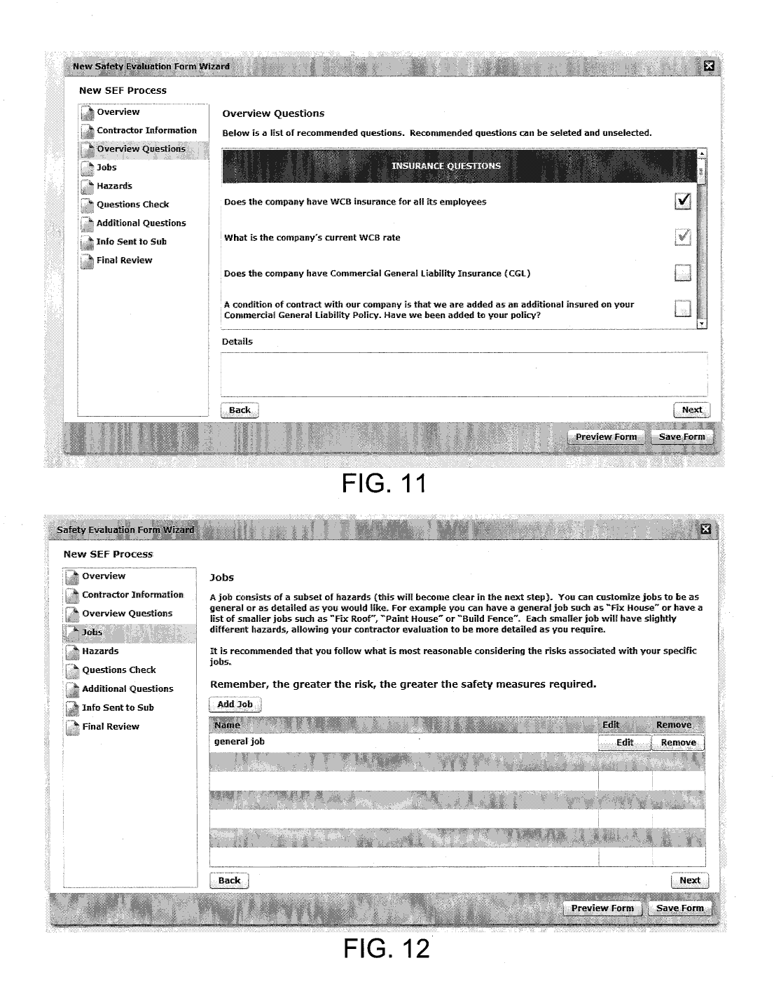

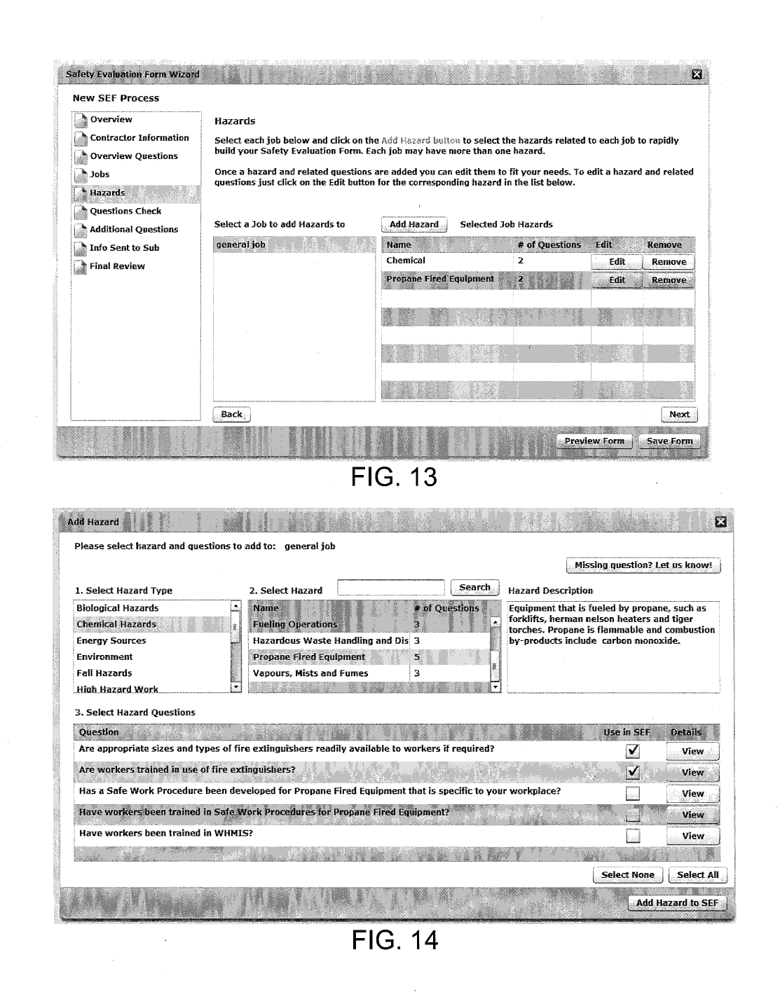

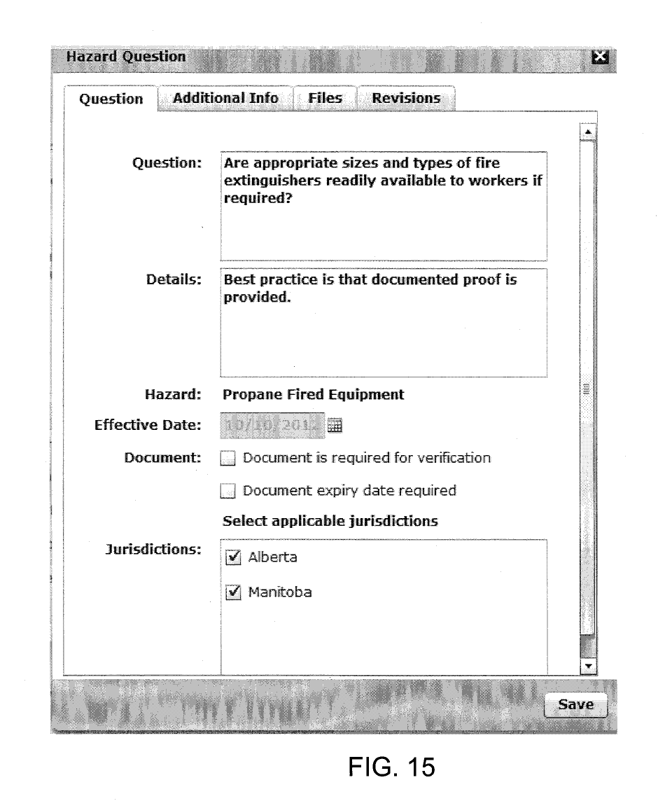

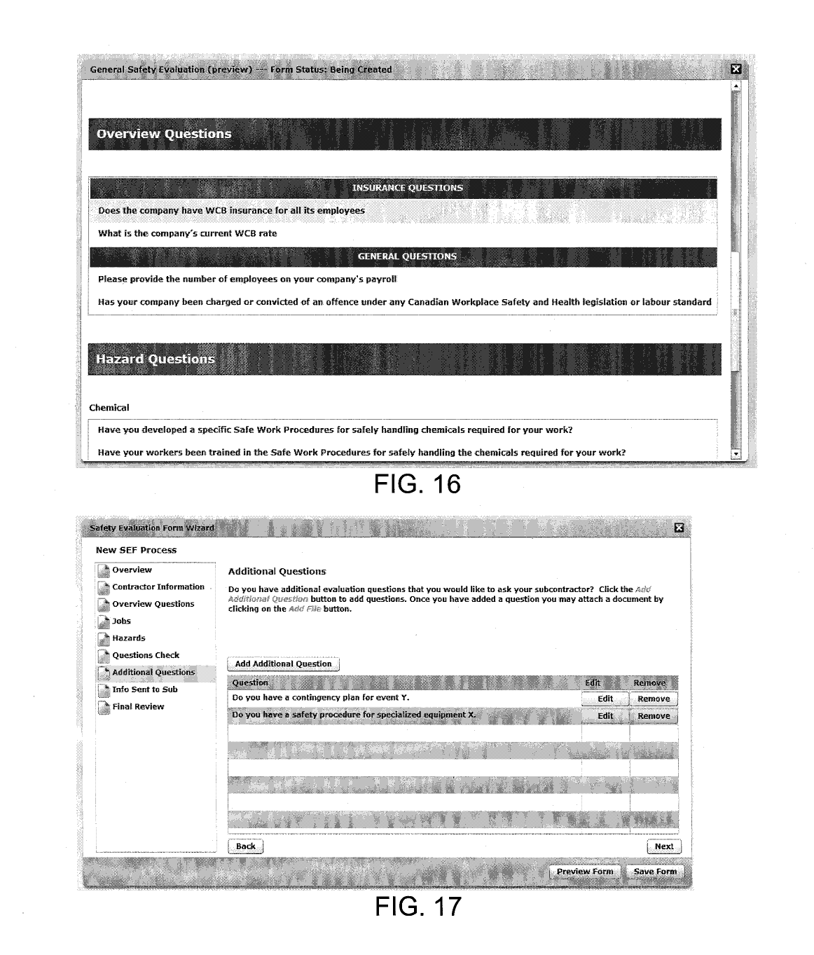

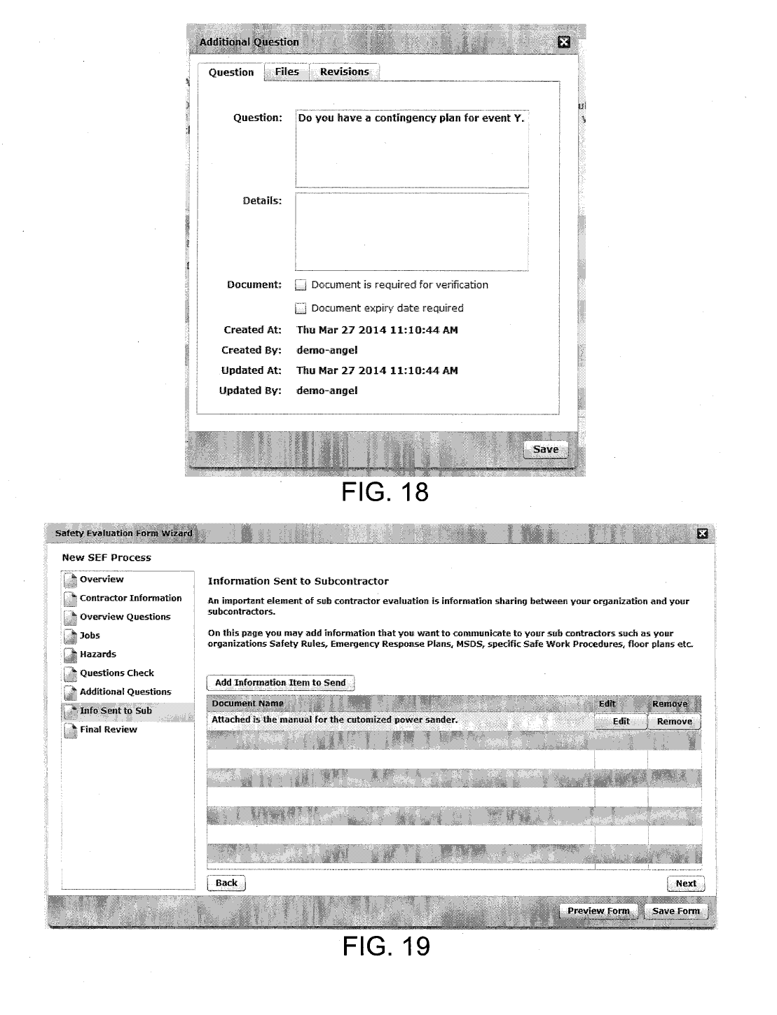

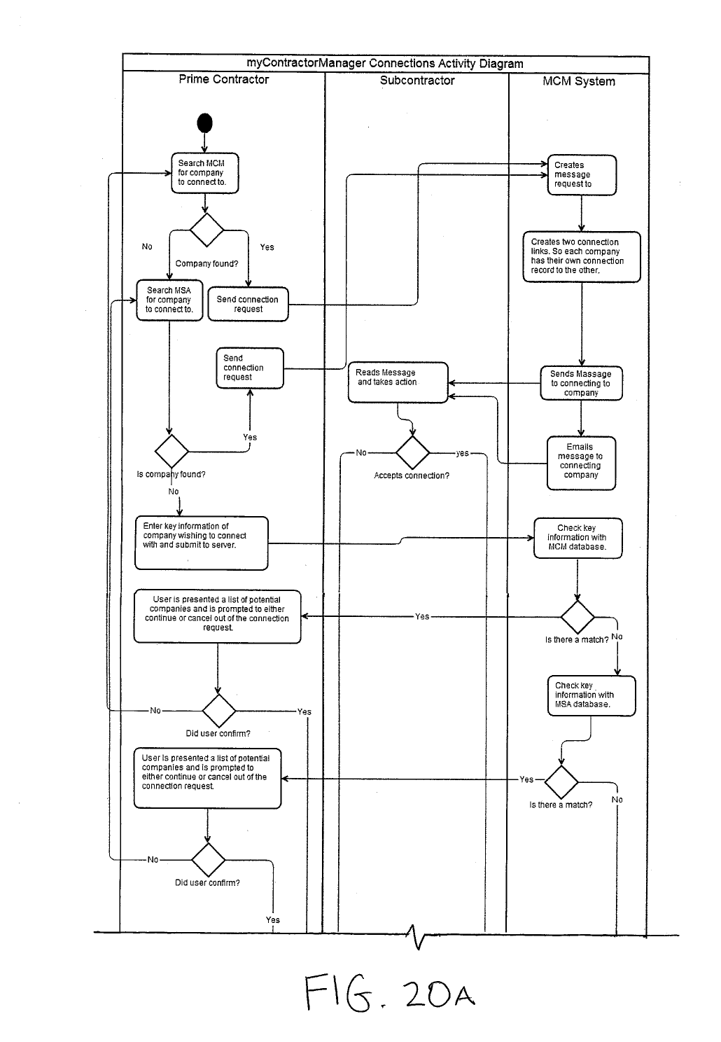

Safety Evaluation Creation Form Process: The present invention is generally referred to herein as the myContractorManager system. The system makes it easy to create safety evaluation forms for prime contractors to evaluation subcontractors in regards to their safety. Safety evaluation forms are easily created through the use of a step-by-step wizard. The wizards consist of nine main screens as follows: Overview, Contractor Information, Overview Questions, Jobs, Hazards, Questions Check, Additional Questions, Info Sent to Sub, and Final Review. With reference to accompany FIGS. 6 to 19, various particular features of the system will now further described.

The first step in using the system is to go through an overview of all the steps the safety evaluation form wizard will go through to create a safety evaluation form.

The second step is to fill in the general form information. The form is given a name, and optionally a project. A subcontractor is selected from a pool of available contractors with whom the user's company has an active connection. The due date is filled entered. The due date is when the subcontractor would like the form back. The system uses this date to send out reminders at certain intervals letting the subcontractor know that they need to have the form completed. The expiry date is used once the form has been accepted. The system will send out reminders at predefined intervals to let the prime contractor know that the form is about to expire. The objective of having forms expire is to let the prime contractors know that the subcontractor might no longer be in compliance and they should re-evaluate them to verify the subcontractor within the safety expectations.

Next, jurisdictions for which the safety evaluation form will apply are selected.

Overview Questions: On the Overview Questions screen, the user is provided with a pool of ready-made questions by professionals. The Overview Questions have two categories: Insurance questions and general questions.

The user can select which questions to add to the safety evaluation form. The system automatically selects high risk questions, however the user can unselect if desired. The system can also set mandatory questions where the user cannot unselect the mandatory question.

Jobs: Jobs are an easy way to group hazards and hazard questions. Each job is broken down to hazards, and in turn, each hazard is made up of a collection of hazard questions (see FIG. 4).

In the Jobs screen, the use first adds the desired jobs. In a later screen they will add the required hazards to each job.

Hazards: The Hazards screen allows the user to add hazards to jobs.

Each hazard is made up of a collection of Hazard Questions. The hazard and hazard questions are entered into the system by safety professionals. Users can quickly add collections of questions by adding a hazard. Users can pick and choose which Hazard Questions are applicable to the current job.

Once the a Hazard and related Hazard Questions have been added to the safety evaluation form, the user can edit both the hazard and hazard question to further customize them to their requirements (See FIG. 12).

Users can require that documentation is provided in order to answer the questions. If this is selected the subcontractor will not be able save the question as answered unless a file is attached.

Users can also require that the attached document have an expiry date. If the document has an expiry date, the system will send out notifications at predefined intervals that the document is about to expire.

Questions Check: At this step of the process, the user is required to preview the safety evaluation form before they proceed.

Additional Questions: Additional questions are custom made questions the user can create to include in the safety evaluation form. Just like all other questions, the user can attach files to it, require that a document be attached to fully answer it, or require a document expiry date on the attached document.

Info Sent to Sub: Users have the option to provide information to the subcontractor. They can easily add documents from the document library to add to the safety evaluation form.

Final Review: In the Final Review screen, users are encouraged to preview their forms once more to make sure it contains the information required. The user can at this point send the safety evaluation form to the subcontractor if they wish to do so.

Safety Evaluation Form Life Cycle: myContractorManager allows users to send safety evaluation forms back and forth. This allows contractors and subcontractors to work together to refine questions and answers in order to create the most complete safety evaluation forms.

The first step in the safety evaluation form life cycle is to actually create the form. Contractors use the Safety Evaluation Form Wizard to easily create safety evaluation forms.

Once the safety evaluation form has been created, the user has the option of deleting it, cancelling it, or sending it to the subcontractor to fill out.

When the form is sent to the subcontractor the contractor cannot edit the form. The safety evaluation form is essentially in the subcontractor's control.

When the safety evaluation form is under the subcontractor's control, the subcontractor user can choose to decline the form, or fill it out and send it back.

Note that the contractor and subcontractor can cancel and decline the forms at any time once the form has been sent to the subcontractor.

When the subcontractor fills out the form and sends it back to the contractor, the contractor reviews the form. At this point the contractor can edit the form and send it back to the subcontractor to fill it out further or the contractor may accept the form. Accepting the form means that the subcontractor has answered the questions to the contractor's satisfactions. The contractor may also choose to reject the form. Rejecting the form means that the subcontractor did not meet the requirements established by the contractor.

Once a form is accepted, the myContractorManager system checks it on a daily basis. At set intervals warnings are sent out the contractor letting them know that the form is about to expire. This allows contractors to create a new safety evaluation form and re-evaluation the subcontractors at required intervals to make sure subcontractors are in compliance.

As described herein, myContractorManager is an online application to digitizes the process of evaluating subcontractors. It uses a user-friendly wizard to quickly create safety evaluation forms. These forms are managed and tracked through the whole lifecycle.

The following terms used in the current specification are defined generally as follows:

MSA: acronym for mySafetyAssistant, a custom software application that myContractorManager interfaces with in order to import existing customer information.

MCM: acronym for myContractorManager.

SEF: acronym for safety evaluation form.

Safety Evaluation Form: a digital representation of a form that contains questions provided by a prime contractor.

Prime Contractor: In the context of myContractorManager is someone who creates and sends safety evaluation forms to other contractors to evaluate them. Note that a company can be a prime contractor and a subcontractor.

Subcontractor: In the context of myContractorManager is a contractor that is being evaluated by a prime contractor via a safety evaluation form that they need to fill out. Note that a company can be a prime contractor and a subcontractor.

ORM: Object relational mapping, a programming technique where virtual structures in memory are used to represent data tables in relational databases. This is a common technique used in modern programming.

MVC: Model-View-Controller complex design pattern used in software development to separate software into three parts, the model—responsible for business logic, the view—used to present the user information, controller—control the program flow. This is a commonly used paradigm in modern software systems.

Soft Delete: Programming technique where a table in a record is flagged in the system as deleted and for all intents and purposes is taken out of the application's processes with the record still existing in the database.

JSON: JavaScript Object Notation—is a web standard way of packaging data for communication between systems.

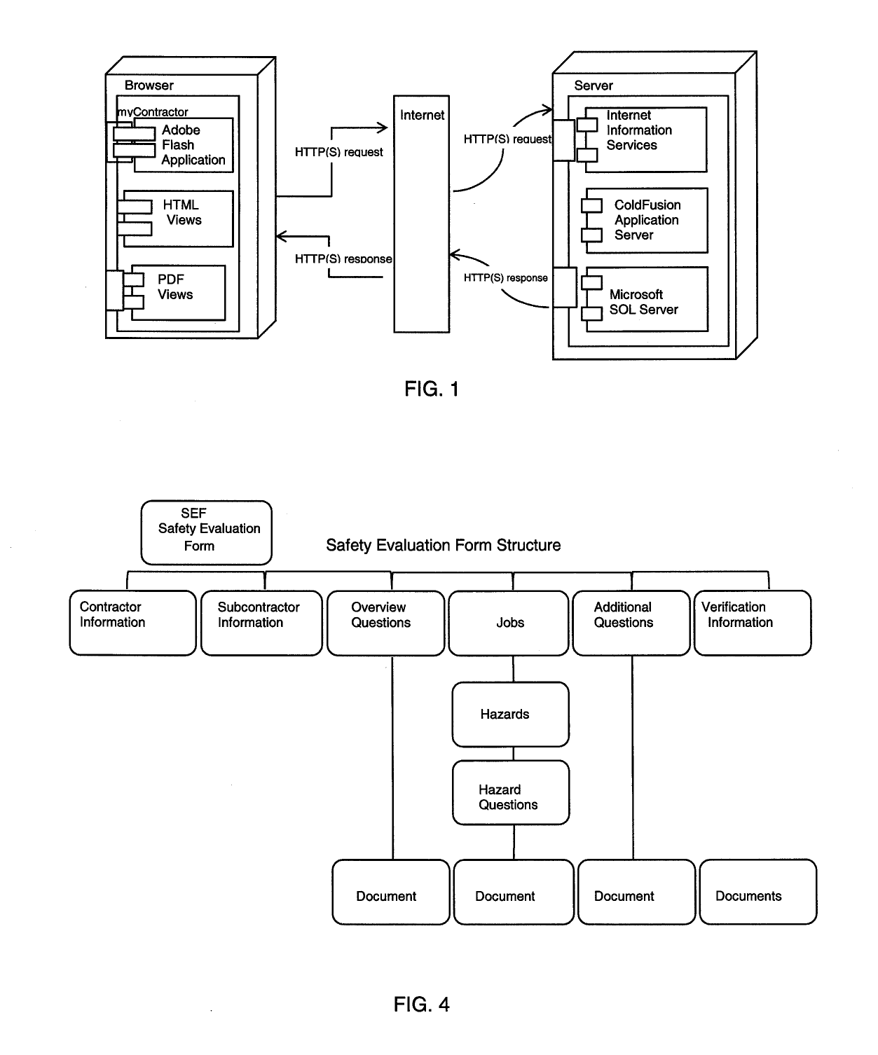

Technology Stack: myContractorManager is a multitier distributed application. The application itself is broken down into two major components, the client side application that runs on the user's browser and the server side application that runs on the 1 Life application server. The client-server communication takes place through the internet via an encrypted connection (see FIG. 1).

The client side application uses three key technologies: the Adobe Flash Player, the user's browser HTML engine, and the user's default PDF reader.

Most of the processing functionality is through the use of the Flash Player. The flash player is used as the main point of interaction between the user and the system.

The server side application also uses three key technologies: Internet Information Services as the web server, ColdFusion at application layer, and Microsoft MSQL server as the database engine.

myContactorManager uses the JSON data-interchange format through the internet via HTTP request/response model for communication.

Software Subsystems, Processes, and Methodologies

Entity Types: myContractorManager has three types of entities for safety evaluation forms, hazards, and questions.

Master Entities: These are master questions/SEFs that users can use to create their own safety evaluation forms. These types of entities are available for all users to copy in the system.

Template Entities: Are templates that the users created themselves. Template entities are only available to the company that created them.

Instance Entities: Are concrete entities used in safety evaluation forms, they are typically based off a master or template entity.

Entity Permissions and Tracking: myContratorManger uses the object relational mapping technique to manage data at the server application level. Database tables are represented as objects in memory. These objects are used to manage data indirectly. This abstraction layer provides a cleaner interface for managing information.

All key entities in myContractorManager have an owner. Ownership is tracked via a company ID property in applicable data sets/entities. Applicable entities may also have fields for tracking when records are created, updated, and soft deleted; and by who these actions were performed.

Key objects are also copied every time they are modified thus creating revisions in separate table for auditing purposes.

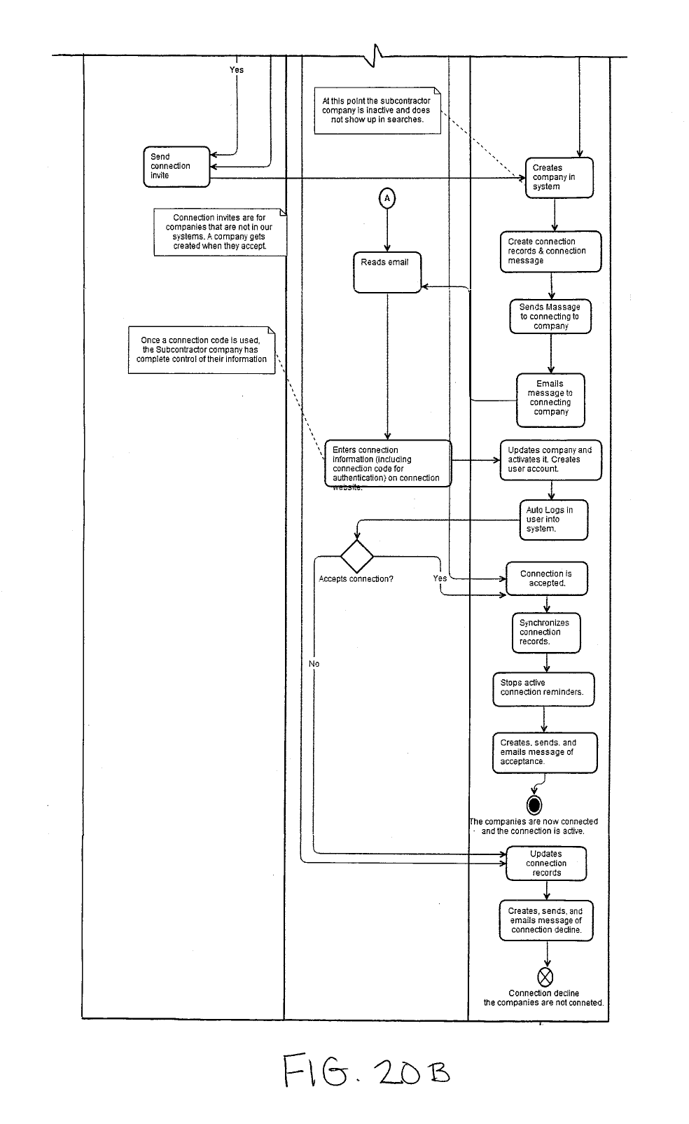

Connections Subsystem: In order for companies to be able to send and receive safety evaluation forms, they first need to establish and active connection. The connection process is illustrated in FIG. 20.

A unique characteristic of the MCM Connections subsystem is that two records are created on the database when a connection is initiated. This is to accommodate ownership permissions, tracking, and to better accommodate ORM programming. Connections records typically have a companyA (the company connected from), companyB (the company connected to), and company) (the owner company). Since companies can connect and disconnect form each other, two connection records are used, each of the connecting companies owns a connection. This simplifies the query performed on the database to see the connections for a particular company. It also simplifies ownership permissions since it would be problematic to discern ownership and tracking since both companies can initiate and update a connection—essentially playing two roles. As explained earlier, companies can be a contractor and a subcontractor, this connection structure facilitates the display of information based on the role being played in a safety evaluation form.

| Connetions | Connetion 1 | Connetion 2 |
|---|---|---|
| companyA | companyA - Company1 | companyA - Company2 |
| companyB | companyB - Company2 | companyB - Company1 |
| companyId | companyId - Company1 | companyId - Company2 |
| . . . | . . . | . . . |

Safety Evaluation Form Wizard: The safety evaluation form wizard is the most important part of myContractorManager. The wizard allows prime contractors to easily create virtual safety evaluation forms from a pool of predefined questions that they can later customize.

The amount of effort to create a customized safety evaluation form is minimal. The wizard takes you through the process of adding jobs, hazard, hazard questions, overview questions, additional question, and verification information. Users can customize existing questions to fit their needs and set specific requirements such as documentation and documentation expiry dates to be entered into the system in order for questions to be answered satisfactorily.

The present system, myContractorManager, also makes it easy for subcontractors to fill out safety evaluation forms.

PDF Generation: myContractorManager has a PDF generation feature that binds together all the questions, answers, and documentation into one PDF file. If the same document is used in multiple questions, the document is only attached once.

Note that PDF generation is just an additional feature and is implemented for client records convenience. Safety evaluation forms are created and completed all digitally through myContractorManager.

Versioning: Web browsers have a tendency to cache media files. The MCM client application is considered by browsers to be a media file and so they tend to cache the file locally. This is a great browser feature since it makes MCM load almost instantly on user's computers. The down side to this is that when a new version is released, browsers more often than not fail to update their cache with the freshest version.

To make sure MCM client version are not out of synch with the server version, a method is used where the HTML page queries the database to get the current application version and uses this returned version as a parameter to load the application. A second method is used within the MCM client application to query the server for the current version and it compares this value with the internal client application version stored with every build. If the client application version is not the same as the server side, the application stops execution and the user is not allowed to continue. They are prompted to clear their cache, thus forcing a fresh copy of the MCM client application onto their computers.

Revisions: All changes are logged for key entities in MCM. When an entity changes, a full copy of it is made as a revision.

Safety Evaluation Form Snapshots: Every time a safety evaluation form changes state, a snapshot is taken. The snapshot builds a primary key inventory of all the assets of the safety evaluation form at one point in time. These snapshots can be used with revisions to rebuild a safety evaluation form as it was at a particular point in time.

SafetyEvaluationFormSnapshot

createdAt
updatedBy
subcontractorId
overviewQuestions
jobs
hazards
hazardQuestions
additionalQuestions
verificationItems

The different allowed states for a safety evaluation form can be seen in FIG. 7.

User Types: myContractorManager supports three types of users:

Super: Used to create safety evaluation form master templates and mater template questions. This user also manages the system configuration.

Administrator: User account that can create safety evaluation forms. Can also create company owned templates for reuse. This user can generate PDF forms.

User: User can only view information.

Guest: Free account that can only receive and complete safety evaluation forms.

Database Structure:

The database structure revolves around the SafetyEvaluationForms table and the Companies Table.

| Table/Entity | Description |
|---|---|
| AdditionalQuestionDocuments | Links additional questions to documents. A |
| | document can only be attached one. |
| AdditionalQuestionRevisionDocuments | Provides a link between |
| | AdditionalQuestionRevisions and Documents |
| | table. Since documents cannot be deleted from |
| | MCM, this link provides a means to see what |
| | documents were attached at a particular time. |
| AdditionalQuestionRevisions | A copy of a record is inserted this table when a |
| | record in AdditionalQuestions is updated. |
| AdditionalQuestions | Holds all additional questions. |
| Agreements | Holds the user agreement that the user has to |
| | agree to when using MCM. |
| ApplicationSettings | Stores application configuration variables. |
| Attachments | Table that holds properties for files attached to |
| | Notes. |
| Companies | Stores company information. |
| CompanyGroups | Holds the types of companies there can be in |
| | MCM (Contractor and Guest) at the moment. |
| Connections | Holds the connections between companies. |
| ConnetionStates | Stores the different states a connection can be in. |
| DocumentDownloads | Keeps track of which documents have been |
| | downloaded and by whom. |
| Documents | Stores records relating to documents in MCM. |
| | The records hold the hashed filename that is |
| | stored on the server. |
| DocumentSafetyEvaluationForms | Utility table used to generate subcontractor |
| | document expiry reminders. |
| DocumentTypes | Holds the types of documents allowed on the |
| | system |
| EmployeeGroups | Stores the types of users on the system. |
| Employees | Stores the users in the system. Users are tied to |
| | a company. |
| EntityTypes | Stores the types of entities on the system. |
| | Different types have different functions. |
| HazardQuestionDocuments | Table that links HazardQuestions and |
| | Documents. |
| HazardQuestionRevisionDocuments | Table that links HazardQuestionRevisions and |
| | Documents. |
| HazardQuestionRevisions | Whenever a HazardQuestions record is updated |
| | a copy is made on this table. |
| HazardQuestions | Stores all the hazard questions in the system |
| HazardRevisions | A copy gets stored on this table every time a |
| | hazard is updated. |
| Hazards | A hazard is an entity with many related hazard |
| | questions. Hazard questions are grouped by |
| | hazard. |
| HazardTypes | Stores the allowed types of hazards in MCM. |
| JobRevisions | Every time a job is updated, a copy gets saved to |
| | this table. |
| Jobs | Jobs are used to store hazards together. |
| Jurisdictions | Stores the jurisdictions that could be applied to a |
| | safety evaluation form. |
| Logins | Stores success login information on users login |
| | into the system. |
| MessageGroups | Store the different types that messages can be |
| | grouped in. |
| Messages | Internal messages sent within MCM. |
| Notes | Text notes attached to safety evaluation forms. |
| NotificationGroups | Categories for notification logs. |
| NotificationLogs | Logs records of schedules notification tasks. The |
| | logs are used to see how many notification go out |
| | and if the task has any problems. |
| Opportunities | When a user has a question regarding a |
| | particular question it is entered as an opportunity. |
| OpportunitityStates | The states an opportunity can be in. |
| OpportunityTypes | The different types an opportunity can be. |
| OverviewQuestionDocuments | Link table for attaching documents to an overview |
| | question. |
| OverviewQuestionRevisionsDocuments | Link table to record overview question revisions to |
| | documents. |
| OverviewQuestionRevision | A copy of an overview question is made every |
| | time the overview question is updated. |
| OverviewQuestions | Stores the overview questions. |
| OverviewQuestionTypes | Different types overview questions can be. |
| Provinces | List of provinces to relate to companies |
| QuestionStates | The states questions are allowed to be in. |
| Reminders | Used to keep track of connection reminders. A |
| | scheduled task is run every day and reminders go |
| | out based on the values of this table. |
| Resources | This is a list of document details provided to users |
| | as a resource. |
| SafetyEvaluationFormRevisions | Every time the content of a SEF is changed a |
| | copy is made for auditing purposes. |
| SafetyEvaluatonForms | Stores the core information related to a safety |
| | evaluation form. |
| SafetyEvaluationFormSnapshots | Stores ids or related entities and time so that they |
| | can be easily referenced and a SEF can be |
| | generated from a snapshot. |
| SafetyEvalutionFormStates | The different states a safety evaluation form is |
| | allowed to be in. |
| ServerLogGroups | List of groups server logs can be grouped in. |
| Server Logs | Stores error and security information from the |
| | system. |
| SubscriptionPlans | Stores the different subscription plans MCM has. |
| Subcriptions | Stores companies subsection information. |
| VerificationItemDocuments | Link between verification items and documents. |
| VerificationItemRevisionDocuments | Used to store the links between documents and |
| | revisions. |
| VerificationItemRevisions | Every time a verification item is modified a |
| | revision is created and store in this table. |
| VerificaitonItems | This is information provided to the subcontractor. |
| | It's not a question, just information. |
| Versions | Stores current version and previous version |
| | information of MCM releases. This information is |
| | sued to verify that the user client is running the |
| | current version of MCM. |

Since various modifications can be made in my invention as herein above described, it is intended that all matter contained in the accompanying specification shall be interpreted as illustrative only and not in a limiting sense.

1. A computer implemented system for exchanging safety information between a primary user and a secondary user, the system comprising:
a server including a system memory storing programming instructions thereon, a form data database storing safety evaluation form data thereon in the form of safety questions relating to safety information, and a user interface arranged to receive input from the primary user and the secondary user;
the programming instructions on the system memory further comprising:
a form generating tool arranged to generate a prescribed safety evaluation form using the safety evaluation form data from the form data database according to input received from the primary user;
a form completion tool arranged to append response data to the prescribed safety evaluation form according to input received from the secondary user to generate a completed form; and
a form reviewing tool arranged to provide access to the completed form by the primary user.

2. The system according to claim 1 further comprising:
the user interface being arranged to receive input from the primary user including custom safety questions; and
the form generating tool being arranged to generate the prescribed safety evaluation form using both the safety evaluation form data from the form data database and the custom safety questions according to the input received from the primary user.

3. The system according to claim 1 further comprising:
the form data database including a plurality of designated categories including a plurality of safety questions associated with each category;
the user interface being arranged to receive input from the primary user including at least one category selection; and
the form generating tool being arranged to generate the prescribed safety evaluation form using the safety questions associated said at least one category selection.

4. The system according to claim 3 further comprising:
the form data database including a plurality of general safety questions independent of the designated categories; and
the form generating tool being arranged to generate the prescribed safety evaluation form using both the safety questions associated said at least one category selection and some of the general safety questions according to the input received from the primary user.

5. The system according to claim 3 further comprising:
the user interface being arranged to receive input from the primary user including a customization selection; and
the form generating tool being arranged to generate the prescribed safety evaluation form using only a portion of the safety questions associated said at least one category selection responsive to said customization selection by the primary user.

6. The system according to claim 1 further comprising:
the user interface being arranged to receive input from the primary user including an attachment document; and
the form generating tool being arranged to generate the prescribed safety evaluation form such that the attachment document is appended therewith.

7. The system according to claim 6 further comprising:
the system memory including a primary user database storing the attachment document thereon; and
the form generating tool being arranged to generate a plurality of different safety evaluation forms using the attachment document stored on the primary user database and the safety evaluation form data from the form data database according to the input received from the primary user.

8. The system according to claim 6 further comprising:
the form generating tool being arranged to append a plurality of attachment documents to different one of the safety questions respectively.

9. The system according to claim 1 further comprising:
the user interface being arranged to receive input from the secondary user including an attachment document; and
the form completion tool being arranged to generate the completed form such that the attachment document appended therewith.

10. The system according to claim 1 further comprising:
the system memory including a user database storing any generated and completed forms thereon; and
the user interface including a display tool arranged to present all forms for selection by the user and display any selected form to the user.

11. The system according to claim 1 further comprising:
the system memory including a user database storing a plurality of user form templates thereon which are accessible to a prescribed user;
the user interface being arranged to receive input from the primary user including a template selection; and
the form generating tool being arranged to generate a prescribed safety evaluation form using the form template corresponding to the template selection together with the safety evaluation form data from the form data database.

12. The system according to claim 11 further comprising:
the user interface being arranged to receive a template customization selection from the primary user; and
the form generating tool being arranged to modify one of the user specific from templates stored on the user database in accordance with the template customization selection from the primary user.

13. The system according to claim 1 further comprising:
the form data database including a plurality of master form templates thereon accessible to a plurality of different users;
the user interface being arranged to receive input from the primary user including a template selection; and
the form generating tool being arranged to generate a prescribed safety evaluation form using the master template corresponding to the template selection together with the safety evaluation form data from the form data database.

14. The system according to claim 13 further comprising:
the system memory including a user database accessible only to a prescribed user;
the user interface being arranged to receive a template customization selection from the primary user; and
the form generating tool being arranged to modify one of the master form templates in accordance with the template customization selection from the primary user and store the modified template on the user database.

15. The system according to claim 1 further comprising:
the user interface being arranged to receive a user authorization from each of the primary user and the secondary user;
the programming instructions on the system memory further comprising a connection management tool;
the connection management tool being arranged to establish an authorized connection between the primary user and the secondary user in response to the user authorization from the primary user and the user authorization from the secondary user;
the connection management tool being arranged to enable display of the generated safety evaluation form to the secondary user only subsequent to the authorized connection between the primary user and the secondary user having been established.

16. The system according to claim 15 further comprising:
the system memory including a connection database;
the connection management tool being arranged to store the authorized connection on the connection database; and
the connection management tool being arranged to enable display to the secondary user of a plurality of different safety evaluation forms generated by the primary user subsequent to the single authorized connection between the primary user and the secondary user having been established.

17. The system according to claim 1 further comprising:
each authorized connection being stored on the connection database as a first connection authorizing communication of forms by the primary user for display to the secondary user and a second connection authorizing communication of forms by the secondary user for display to the primary user.

18. The system according to claim 1 further comprising:
the programming instructions on the system memory further comprising a communication management tool; and
the communication management tool being arranged to send a notification through a communications network to the secondary user upon generation of the prescribed safety evaluation form by primary user using the form generating tool.

19. The system according to claim 1 further comprising:
the programming instructions on the system memory further comprising a communication management tool; and
the communication management tool being arranged to send a notification through a communications network to the primary user upon generation of the completed form by the secondary user using the form completion tool.

20. The system according to claim 1 further comprising:
the form reviewing tool being arranged to associate a status of the response data in relation to each question on the completed form using status input received from the primary user using the user interface.

21. The system according to claim 1 further comprising:
the form reviewing tool being arranged to associate an accepted status or a rejected status to the response data within the completed form using status input received from the primary user using the user interface; and
the system being arranged to enable further response data from the secondary user to be appended to the prescribed safety evaluation form using the form completion tool in response to a rejected status being associated with the completed form using the form reviewing tool.

22. A method of exchanging safety information between a primary user and a secondary user using the system according to claim 1, the method comprising:
receiving safety data selection information from the primary user through the user interface;
using the form generating tool, creating a safety evaluation form using safety evaluation form data from the form data database selected according to the safety data selection information from the primary user;
receiving response data from the secondary user through the user interface;
using the form completion tool, creating a completed form comprising the safety evaluation form and the response data appended thereto; and
using the form reviewing tool, enabling the primary user to view the completed form.
